(19) United States
(12) Patent Application Publication
(10) Pub. No.: US 2021/0097870 A1
(43) Pub. Date: Apr. 1, 2021

(54) FLIGHT MANAGEMENT SYSTEM, METHOD, AND PROGRAM

(71) Applicant: NEC Corporation, Minato-ku , Tokyo (JP)

(72) Inventors: Shinji NAKADAI, Tokyo (JP); Manao MACHIDA, Tokyo (JP); Hiroaki INOTSUME, Tokyo (JP)

(73) Assignee: NEC Corporation, Minato-ku, Tokyo (JP)

(21) Appl. No.: 16/630,027

(22) PCT Filed: Nov. 30, 2017
(86) PCT No.: PCT/JP2017/043065

§ 371 Date: Jan. 10, 2020

Related U.S. Application Data
(60) Provisional application No. 62/532,547, filed on Jul. 14, 2017.

(51) Int. Cl. G08G 5/00; G06Q 10/10; G06Q 50/14; G06Q 30/08; G06Q 10/02; G06Q 20/12; G06Q 30/02; G06Q 50/26; G06Q 30/00; G06Q 50/00

(52) U.S. Cl. CPC G08G 5/0039; G08G 5/0017; G08G 5/006; G06Q 10/10; G06Q 50/14; G06Q 50/01; G06Q 10/02; G06Q 20/1235; G06Q 30/0206; G06Q 50/265; G06Q 30/0185; G06Q 30/08

(57) ABSTRACT

A flight management system (500) according to the present invention is provided with: an airspace information management unit (501) which manages airspace information, which is information related to an airspace represented by means of a three-dimensional spatial region and a temporal interval; an unapproved flight plan management unit (502) which, upon reception of a flight plan for a moving body, manages the flight plan in association with a combination of airspaces to be used in the flight plan, on the basis of the airspace information; and a flight plan approving unit (503) which, on the basis of the airspace information and the association described above, detects at least a conflict or an interference of airspaces between a plurality of flight plans, and approves or disapproves the flight plan on the basis of the result of detection.

### TECHNICAL FIELD

The present invention relates to a flight management system, a flight management method, and a flight management program for managing flight of a moving body.

### BACKGROUND ART

The utilization of Unmanned Aircraft System (UAS) such as drones for air transportation has been considered. In a situation where a plurality of UASs flies simultaneously, a mechanism for determining possibility of collision and approving/disapproving flight is required in order to avoid collision between UASs. Therefore, various methods of managing UASs (UAS Traffic Management (UTM)) have been studied. In addition to the UAS, in a moving body flight management system managing flight (traffic) of a moving body that does not have a predetermined moving path such as a road or a railroad, region management and region operation are important in order to achieve both safety and flexible flight services. In the following description, a system that manages flight of such moving bodies is referred to as a flight management system or a UTM system regardless of whether the space used as moving paths of the moving bodies is two-dimensional or three-dimensional.

The UTM system includes, for example, a flight plan management system that manages and approves the flight plan of a moving body submitted before operation, and an actual flight management system that controls the actual operation of a moving body on the basis of the flight plan approved by the flight plan management system.

As a more practical configuration of the flight plan management system, not only a configuration in which an operator (UAS Operator, UASO) who makes a flight plan of a UAS submits the flight plan directly to the flight plan management system, but also a configuration in which the operator connects to the flight plan management system via a service provider (UAS Service Provider, UASSP) may be considered. Hereinafter, the UTM system including the flight plan management system and the actual flight management system as described above may be referred to as an integrated flight management system or Flight Information Management System (FIMS).

As a technique related to the flight management of UASs, there are systems described in, for example, Patent Literature (PTL) 1 and PTL 2. As a technique related to route planning between a plurality of moving bodies including a UAS and self-serving operators of the moving bodies, there is, for example, a technique described in Non Patent Literature (NPL) 1.

The systems described in PTLs 1 and 2 divide the sky into regions, and issue a flight permission in a region within a certain time zone as a license. According to such a method, the number of UAS flying in the same region within a certain time zone can be limited by defining the number of licenses to be issued. Hereinafter, resultant obtained by dividing the sky by region and time is called airspaces.

In particular, in the system described in PTL 1, it is assumed that the license is bought and sold by auction or the like, and it is expected that the license can be assigned to a UAS having a more important flight plan by the economic mechanism (for example, the price reflects the degree to which the flight service company wants to obtain a license.).

In the system described in PTL 2, it is assumed that the landowner of the land corresponding to an airspace has the airspace license, and the UAS operator can fly in the airspace by purchasing the license for the airspace from the landowner.

The system described in NPL 1 introduces a combination auction for a route plan of a plurality of self-serving moving bodies. The auctioneer (organizer of an auction) side sets a lowest bid price for a route plan of each moving body, and an operator of each moving body bids for his/her route plan at a price equal to or higher than the set lowest bid price. Upon accepting a bid for the plan, the auctioneer ascend the lowest bid price of a route plan that would cause a collision with another moving body (hereafter, a situation where equal to or more than a predetermined number of moving bodies would collide or interfere with each other when the moving bodies move according to the path plan is expressed that the flight plans of the moving bodies, which would collide or interfere with each other, conflict with each other). By repeating this process of bidding and ascending bid price, each moving body can make an efficient route plan without conflict.

### CITATION LIST

### Patent Literature

PTL 1: U.S. Pat. No. 9,508,264
PTL 2: Internal Publication No. 2017/044079

### Non Patent Literature

NPL 1: Ofra Amir, Guni Sharon, and Roni Stern, “Multi-Agent Pathfinding as a Combinatorial Auction.”, In AAAI, 2015.

### SUMMARY OF INVENTION

### Technical Problem

The systems described in PTLs 1 and 2 issue a license for each airspace to control the number of UASs flying in each airspace. However, a flight plan generally includes a plurality of airspaces, and licenses for all airspaces included in the route of the flight plan are required to fly as planned.

The systems described in PTLs 1 and 2 do not consider any method for obtaining a license for a route including a plurality of airspaces. There may be some cases, in which licenses for only some of airspaces to be used in a flight plan can be purchased. In this case, the UAS operator who purchased the license cannot operate flight because he/she does not have licenses for airspaces required for the plan, and the purchased license is wasted. In addition, even when the airspace of which the license was purchased is not actually used and thus the airspace is available for flight, the airspace cannot be used because another operator cannot purchase the license.

For example, as shown in FIG. 13, it is assumed that a UAS operator α has a flight plan having a start point S and a goal point G, two airspaces A and B are on the route between the points, and other UAS operators β and γ hope to obtain licenses for the two airspaces A and B. More specifically, the UAS operators α and γ hope to obtain a license for the airspace A, and the UAS operators α and β hope to obtain a license for the airspace B. In this case, if each UAS operator has a predetermined budget for his/her flight plan, each UAS operator will compete for licenses for the airspaces A and B under budget constraints. As a result of auctioning only one license for each of the airspaces A and B, for example, a situation may occur in which the UAS operator α makes a successful bid for a license for the airspace A at a price 4 and the UAS operator β makes a successful bid for a license for the airspace B at a price 2.

In such a situation, as shown in FIG. 14, the UAS operator α wastes the license fee for the airspace A, and the UAS operator γ cannot use the airspace A even though it is not used by anyone.

In order to solve such an unfavorable situation, it is desirable to allow purchase of a license for a combination of airspaces to be used in a flight plan, instead of purchasing a license for each of the airspaces. This is similar to a situation where left and right shoes are purchased as a pair at 2000 yen instead of purchasing the right shoe of the pair at 1000 yen and the left shoe of the pair at 1000 yen separately. If such an auction considering a combination of a plurality of elements can be applied to a combination of airspaces used in a flight plan, efficient use of airspaces can be realized while reducing unnecessary payment from a UAS operator.

According to the technique described in NPL 1, it is possible to auction a combination of points and lines representing a route as an auction item. However, in NPL 1, an auction item is a combination of points and lines defined on a graph. More specifically, on a graph defined corresponding to a map or geographic information as shown in FIG. 15, a route generated by selecting points and lines becomes an auction item (see FIG. 16). Further, since the collision with another moving body in NPL 1 means only passing through the same point or line at the same time, there may be a problem in safety when the distance between the points is small with respect to the actual size or moving speed of the moving body.

The flight plan for controlling a UAS is generally implemented by a method specifying point information on a route called waypoints. Here, latitude, longitude and altitude are often used as a waypoint. A UAS flies according to the flight plan by passing through the latitudes, longitudes and altitudes of the specified waypoints in order.

However, when a flight plan by waypoints specifying is used, the waypoints specified in the flight plan cannot be directly associated with points on the graph described in NPL 1. Thus, the technique of the NPL 1 cannot be directly applied. A waypoint is only information about a route point, and a flight plan does not define the details (moving paths, moving speed, etc.) of the movement from one route point to the next route point. When a UAS moves between route points, there may be a case where the speed is not constant or a case where the UAS waits at a point in the middle.

In addition, the latitude, longitude, and altitude can be specified very precisely in a flight plan. Thus, even if two UASs specify different waypoints, there is a possibility of collision between the UASs if those waypoints are close to each other. In practice, the waypoint and the actual flight position of a UAS may differ. In consideration of these circumstances, it is desirable to have a flight management system that enables each UAS operator to operate a UAS according to a flight plan safely, while reducing waste in terms of regional resources and cost of each UAS operator by resolving conflicts among the UAS operators on the basis of economic principles.

Accordingly, it is an object of the present invention to provide a flight management system, a flight management method, and a flight management program capable of safely and efficiently using the sky while reducing unnecessary payment from a company that operates a moving body (UAS operator).

### Solution to Problem

A flight management system according to the present invention includes an airspace information management unit which manages airspace information, which is information related to an airspace represented by means of a three-dimensional spatial region and a temporal interval, an unapproved flight plan management unit which, upon reception of a flight plan for a moving body, manages the flight plan in association with a combination of airspaces to be used in the flight plan, on the basis of the airspace information, and a flight plan approving unit which, on the basis of the airspace information and the association described above, detects at least a conflict or an interference of airspaces between a plurality of flight plans, and approves or disapproves the flight plan on the basis of the result of detection.

A flight management method according to the present invention is performed by an information processing apparatus, and the flight management method includes managing airspace information, which is information related to an airspace represented by means of a three-dimensional spatial region and a temporal interval, upon reception of a flight plan for a moving body, managing the flight plan in association with a combination of airspaces to be used in the flight plan, on the basis of the airspace information, and on the basis of the airspace information and the association described above, detecting at least a conflict or an interference of airspaces between a plurality of flight plans, and approving or disapproving the flight plan on the basis of the result of detection.

A flight management program according to the present invention causes a computer to store airspace information, which is information related to an airspace represented by means of a three-dimensional spatial region and a temporal interval in a predetermined storage device, upon reception of a flight plan for a moving body, store the flight plan in association with a combination of airspaces to be used in the flight plan, on the basis of the airspace information in a predetermined storage device, and on the basis of the airspace information and the association described above, detect at least a conflict or an interference of airspaces between a plurality of flight plans, and approve or disapprove the flight plan on the basis of the result of detection.

### Advantageous Effects of Invention

According to the present invention, it is possible to safely and efficiently use the sky while reducing unnecessary payment from a company (UAS operator) that operates a moving body.

### BRIEF DESCRIPTION OF DRAWINGS

FIG. 1 is a schematic diagram of an integrated flight management system 500 of a first exemplary embodiment.

FIG. 2 is a block diagram showing a more detailed configuration example of a flight plan management system 51.

FIG. 3 is an explanatory diagram showing an example of the airspace information managed by an airspace database 200.

FIG. 4 is a flowchart showing an operation example of the integrated flight management system 500 of the first exemplary embodiment.

FIG. 5 is an explanatory diagram showing an example of airspaces in an airspace license auction.

FIG. 6 is an explanatory diagram showing an example of assignment of airspaces after approval of a flight plan.

FIG. 7 is a block diagram showing a more detailed configuration example of the flight plan management system 51.

FIG. 8 is a schematic diagram of an integrated flight management system 500 of a second exemplary embodiment.

FIG. 9 is a block diagram showing a configuration example of the integrated flight management system 500 of the second exemplary embodiment.

FIG. 10 is an explanatory diagram showing an example of information added to airspace information.

FIG. 11 is a schematic block diagram showing a configuration example of a computer according to each exemplary embodiment of the present invention.

FIG. 12 is a block diagram showing an outline of a flight management system of the present invention.

FIG. 13 is an explanatory diagram showing an example of airspaces.

FIG. 14 is an explanatory diagram showing an example of assignment of airspaces.

FIG. 15 is an explanatory diagram showing an example of a graph on which a route is specified in NPL 1.

FIG. 16 is an explanatory diagram showing an example of a route treated as an auction item in NPL 1.

### DESCRIPTION OF EMBODIMENTS

### First Exemplary Embodiment

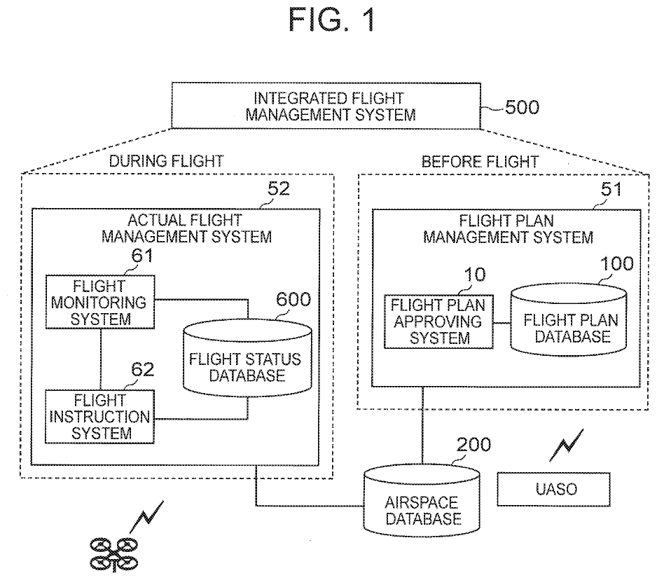

An exemplary embodiment of the present invention will be described below with reference to the drawings. FIG. 1 is a schematic diagram of an integrated flight management system 500 as an example of a flight management system (UTM System) of the present invention.

The integrated flight management system 500 is roughly divided into a flight plan management system 51 related to a flight plan of a UAS generated before flight of the UAS and an actual flight management system 52 having functions used during the flight of the UAS. It should be noted that the setting of airspaces is performed in advance at the integrated flight management system 500, and information about each airspace is stored in a database (for example, an airspace database 200) accessible from each of the flight plan management system 51 and the actual flight management system 52. The flight plan management system 51 includes, for example, a flight plan approving system 10 and a flight plan database 100. The actual flight management system 52 includes, for example, a flight monitoring system 61, a flight instruction system 62, and a flight status database 600.

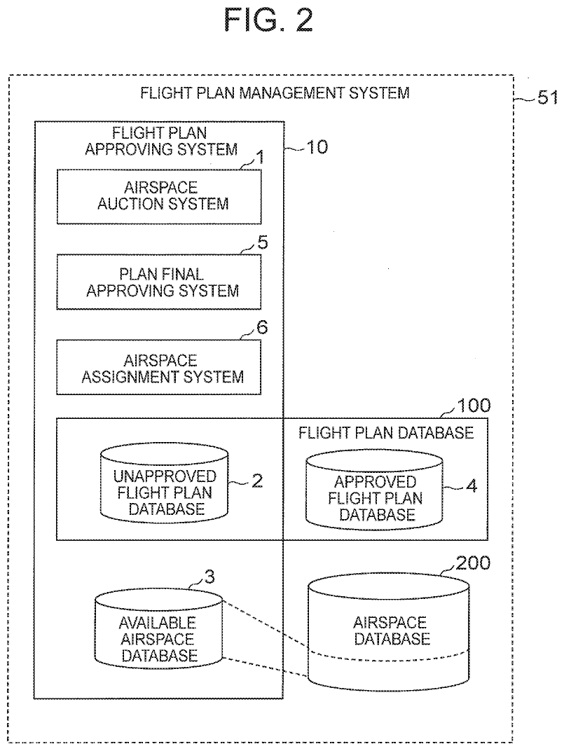

FIG. 2 is a block diagram showing a more detailed configuration example of the flight plan management system 51. In this example, the flight plan database 100 includes an unapproved flight plan database 2 and an approved flight plan database 4.

In the flight plan management system 51, the flight plan is associated with airspaces. The flight plan management system 51 may store a flight plan represented by a combination of waypoints each including, for example, longitude, latitude, altitude and time, in association with a combination of airspaces including the waypoints related to the flight plan.

In the airspace database 200, information about the airspaces used in the flight plan (a UAS operates in the airspaces) is also registered.

The flight plan approving system 10 prompts the UAS operator or the like to submit a flight plan and present a bid price of the flight plan (hereinafter submission and bid price presentation are collectively referred to as “bid”). The flight plan approving system 10 then efficiently resolves the conflict of such bids using an auction, and in response to the result, approves a submitted flight plan, and requests payment corresponding to the bid price of the approved flight plan.

As a configuration for such operation, the flight plan approving system 10 includes an airspace auction system 1, a plan final approving system 5, and an airspace assignment system 6. The airspace auction system 1 makes a flight plan and conducts an auction referring to the unapproved flight plan database 2 and an available airspace database 3. The plan final approving system 5 approves the flight plan on the basis of the auction result by the airspace auction system 1. The plan final approving system 5 also notifies the UAS operator or the UASSP who submitted the flight plan of the payment amount for the approved flight plan. The airspace assignment system 6 assigns an airspace use permission (license) to the UAS operator or the UASSP who submitted the flight plan approved by the plan final approving system 5. It should be noted that the notification of the payment amount for the flight plan may be made by the airspace auction system 1 upon receipt of the auction result, or the airspace assignment system 6 when assigning a license, in addition to the plan final approving system 5.

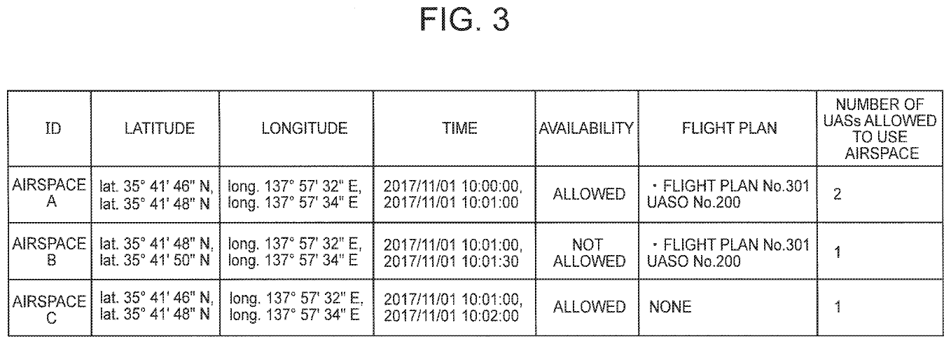

FIG. 3 is an explanatory diagram showing an example of the airspace information managed by the airspace database 200. As shown in FIG. 3, the airspace information may include information related to an airspace including coordinate information, availability, and a flight plan (or a UAS operator, a UASSP) that uses the airspace. In addition, in a case where a predetermined number or less of UASs are allowed to fly in an airspace, the airspace information may further include information such as the number of UASs that can fly in the airspace and the successful bid price of the airspace. It should be noted that for each airspace, the position, size, time period, and the number of UASs allowed to be operated in the airspace, and the like are usually set by the integrated flight management system 500.

The coordinate information of the airspace has information representing a space and information representing time (a position on the time axis having a certain width). For example, the coordinates of an airspace may be represented by the following 2 pieces of position information (latitude, light, and altitude) and 2 pieces of time information. The position information and the time information include not only information directly indicating the position and the time, but also information indirectly indicating the position and the time, such as a relative position and a relative time with respect to an index or a predetermined reference. For example, the information ((lat. 35° 41′ 46″ N, lat. 35° 41′ 48″ N), (long. 137° 57′ 32″ E, long. 137° 57′ 34″ E), (altitude: 100 m, altitude: 110 m), and (time 2017/10/31/09:44:20, time 2017/10/31/09:46:20)) indicates an airspace of a rectangular parallelepiped space from lat. 35° 41′ 46″ N to lat. 35° 41′ 48″ N, from long. 137° 57′ 32″ E to long. 137° 57′ 34″ E, and from altitude: 100 m to altitude: 110 m from time: 09:44:20 of Oct. 31, 2017 to time: 09:46:20 of Oct. 31, 2017.

The available airspace database 3 stores information of available airspace among the airspace information stored in the airspace database 200. The airspace information of the available airspace database 3 includes lowest bid price information according to the auction mechanism in addition to the airspace information of the airspace database 200. The lowest bid price information may be managed in a lowest bid price database, etc. (not shown), separately from the airspace database.

In addition, as a method of associating a flight plan with an airspace, the integrated flight management system 500 may associate them only on the basis of a flight plan submitted by a UAS operator or the like. Alternatively, a UAS operator or the like may specify an airspace to be associated with his/her own flight plan, or the integrated flight management system may associate a flight plan with an airspace on the basis of aircraft information or the like that is supplement to the flight plan provided by the UAS operator.

For example, when a UAS operated by a UAS operator is larger than a usual UAS and requires a wider safety margin, the UAS operator may additionally transmit information of the size of the aircraft to the integrated flight management system 500. In this case, in addition to the airspace on the route specified in the flight plan, the integrated flight management system 500 may also associate an airspace adjacent to the airspace with the flight plan. It is also possible to set a safety margin on the basis not only of the size of the aircraft but also of functions such as the avoidance performance of the aircraft. For example, for a UAS with low avoidance performance, a wider safety margin may be set. The unapproved flight plan database 2 may include, in association with the flight plan, an aircraft information management database (not shown) that stores information about aircraft information related to the safety margin.

In addition to the methods of association of a flight plan and an airspace described above, there may be a method in which a UAS operator specifies a distance from the waypoint and the integrated flight management system 500 determines an airspace according to the specified distance, a method in which a UAS operator side may directly specify an airspace to be used, and the like.

When a UAS operator side directly specifies an airspace to be used, there may be a case where the UAS operator may freely specify an airspace to be associated with the flight plan under an airspace condition for restriction set by the integrated flight management system 500. For example, if the airspace condition set by the integrated flight management system 500 is that an airspace includes a waypoint representing a flight plan, is a region having a radius of 5 m or more and 20 m or less from a specified position of the waypoint, and has a temporal interval of 10 seconds or more and 1 minute or less before and after the specified time, the UAS operator freely sets an airspace to be associated with the flight plan within the restriction.

In such a case where a UAS operator freely sets an airspace, there may be a case where an airspace is not divided exclusively. In this case, the flight plan approving system 10 should add not only an airspace that is set and used in the flight plan by the UAS operator but also an airspace overlapping with the airspace as airspaces associated with the flight plan. For example, in a case where an airspace A specified by a USA operator and an airspace B set by the integrated flight management system 500 have overlapping portions, the flight plan for flying within the airspace A is associated with the airspace B as well as the airspace A.

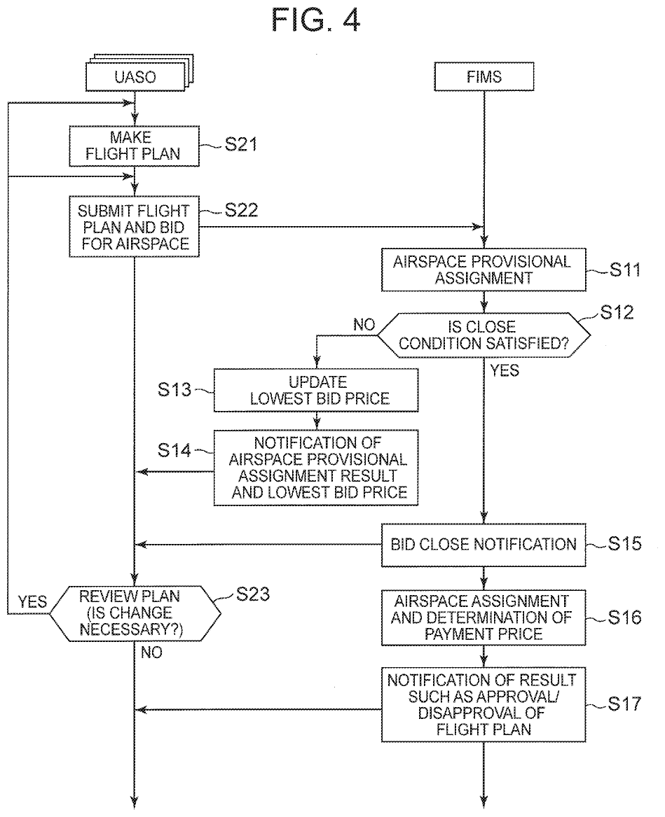

FIG. 4 is a flowchart showing an operation example of the integrated flight management system 500 of the present exemplary embodiment. The example shown in FIG. 4 is an example of the operation from submission of a flight plan by a UAS operator (or the UASSP) to approval of the flight plan by the integrated flight management system 500 (more specifically, the flight plan management system 51).

In this example, first, the UAS operator makes a flight plan (step S21). For example, the UAS operator makes a flight plan considering a lowest bid price of each airspace. As an example, in a case where a budget for a flight plan of a UAS operator is price 3, and the total of the lowest bid price of each airspace used in the flight plan is the price required for the flight plan, the UAS operator has to make a flight plan without using, at least, an airspace having price 4 or higher as the lowest bid price.

The initial setting of a lowest bid price of each airspace may be performed by the flight plan management system 51. The flight plan management system 51 may set the same price for each airspace, or may set a price individually on the basis of past flight status and the like or weather information. For example, the lowest bid price may be set higher for an airspace where congestion is predicted. This raises the bar for using an airspace where congestion is predicted, and thus it is expected to ease congestion. Alternatively, the initial lowest bid price may be set high and then the lowest bid price may be updated by, for example, lowering the lowest bid price when there is no bid.

In step S22, the UAS operator submits a flight plan and bids for an airspace to be used in the flight plan. At this time, the UAS operator bids for the flight plan, and the flight plan approving system 10 (more specifically, the airspace auction system 1) receives the bid and converts the bid for the flight plan into a bid for the airspace to be used in the flight plan. The way of associating a bid for a flight plan with a bid for an airspace is determined according to the mechanism of the auction, and can be any of various ways. For example, a bid of bid price 3 for a flight plan using the airspaces A and B may be associated with a bid for each airspace, for example, a bid of bid price 1 for the airspace A and a bid of bid price 2 for the airspace B, or may be associated with a bid for a combination, for example, a bid of bid price 3 for a combination of the airspace A and the airspace B.

Below are some specific examples of how a bid price of a flight plan can be associated with a bid for an airspace.

As a simple example, a method of allotting a bid price of a flight plan to airspaces used in the flight plan is described. As an auction mechanism, it is assumed here that in order to bid for an airspace, it is necessary to present a bid price equal to or higher than a lowest bid price of that airspace. For example, in a case where the lowest bid price of the airspace A is 1, the lowest bid price of the airspace B is 2, and the lowest bid price of an airspace C is 3, the lowest bid price of a flight plan using the airspaces A, B, and C is computed as 1+2+3=6. Therefore, the UAS operator may bid a price of 6 or higher for the flight plan using the airspaces A, B and C. On the other hand, the flight plan approving system 10 side, which has accepted the bid specifying the flight plan, allots the bid price of the flight plan to the airspaces to be used in the flight plan so as to be equal to or higher than the lowest bid price of each airspace as much as possible.

For example, upon reception of a bid for a flight plan using the airspaces A, B, and C, the flight plan approving system 10 should associate the prices so that the bid price of the airspace A is 1 or higher, the bid price of the airspace B is 2 or higher, the bid price of the airspace C is 3 or higher, and the total of the bid prices for the airspaces A, B, and C matches the bid price of the flight plan. On the other hand, a bid for a flight plan that cannot be associated as described is treated as a bid whose price is lower than the lowest bid price by the flight plan approving system 10.

Next, a method of directly assigning the bid price of the flight plan as is to all of the airspaces used in the flight plan will be described. In this method, a bid price that is the same as the bid price of the flight plan is set as a bid price of all airspaces used in the flight plan. In this example as well, as an auction mechanism, it is assumed that in order to bid for an airspace, it is necessary to present a bid price equal to or higher than a lowest bid price of that airspace. In this example, when the lowest bid price of the airspace A is 1, the lowest bid price of the airspace B is 2, and the lowest bid price of the airspace C is 3, the lowest bid price of the flight plan using the airspaces A, B, and C is MAX {1, 2, 3}=3. Therefore, the UAS operator should bid at a price of 3 or higher for the flight plan using the airspaces A, B, and C. On the other hand, the flight plan approving system 10 side, which has accepted the bid specifying the flight plan, sets the bid price specified for the flight plan to all of the airspaces used in the flight plan.

For example, upon reception of a bid for a flight plan using the airspaces A, B, and C at a bid price 5, the flight plan approving system 10 associates a bid price 5 with the airspace A, a bid price 5 with the airspace B, and a bid price 5 with the airspace C.

There may also be a plurality methods of bidding for a flight plan. For example, there may be a case where a UAS operator selects a plurality of flight plans as candidates, and bids for approval of one of the flight plans. In particular, a transport drone, etc. may take a plurality of routes from a departure point to a destination point. The UAS operator may make one bid specifying a plurality of flight plans corresponding to the plurality of routes and obtain approval for one of the flight plans.

It is also possible for the UAS operator to bid with specification of information such as a departure point, departure time, a destination point, arrival time, aircraft information, a bid price, etc. as a flight plan. At this time, the flight plan approving system 10 may make one or more route plan(s) for the submitted flight plans on the basis of the information included in the flight plans, and make a bid associating bids for airspaces required for the route plans. At this time, as an airspace required for a route plan, an airspace considering the safety margin computed from the aircraft information, etc. may be associated.

Next, the flight plan approving system 10 determines airspace provisional assignment on the basis of the bid price of the flight plan (more specifically, the airspace associated with the flight plan and the bid price thereof), for which the UAS operator bid (step S11). Here, “airspace assignment” means presenting a flight plan that is allowed to use the airspace, and “airspace provisional assignment” means presenting a flight plan that will be allowed to use the airspace at the end of the auction if no new bid is made thereafter. During an auction, airspace provisional assignment is made according to bid prices, and the current provisional assignment at the end of the auction becomes an actual assignment. The provisional assignment information may include information such as a bid price. The type of provisional assignment that is made according to the bid price depends on the auction mechanism.

For example, in an ascending price auction in which only one item is auctioned, each bidder places a bid on the item, and a provisional assignment of the item is made to a bidder who offers the highest bid price. A lowest bid price is then set higher than the highest bid price at that time since it is an ascending price auction. If no new bid is made thereafter, the provisionally assigned bidder obtains the item at the end of the auction. When a new bid of a higher bid price is made, the auctioneer updates the provisional assignment of the item to the bidder. In this example, the airspace corresponds to the item, and the UAS operator or the flight plan corresponds to the bidder.

In step S12, the flight plan approving system 10 checks the close condition of the auction. There are various auction close conditions. For example, the auction may be closed at a certain time, the auction may be closed when the number of updates of the provisional assignment is equal to or more than a certain number, or the auction may be closed when a certain time elapses from the last bid. In addition, it is possible to close the auction only for some of airspaces, such as a part of airspaces being auctioned, or to add a part of airspaces, such as a part of airspaces that has not been auctioned as new auction items.

In step S13, the flight plan approving system 10 updates the lowest bid price. The lowest bid price indicates the lowest bid price required to bid for an airspace (or a combination of airspaces). The UAS operator can compute the lowest bid price of the flight plan from the information of the lowest bid price. The lowest bid price is determined according to the current bid price, the method of provisional assignment of bids, and the auction mechanism. The lowest bid price required for the flight plan, which is computed from the lowest bid price, is also determined according to the mechanism of airspace provisional assignment and the auction mechanism.

For example, there may be an auction in which a bid is made for a flight plan as described below. That is, in the auction, a lowest bid price, which is the lowest price required to bid for a flight plan, is set to the highest price among the lowest bid prices for airspaces included in a combination of airspaces used in the flight plan. In this auction mechanism, when, for example, a lowest bid price of the airspace A is 1, a lowest bid price of the airspace B is 3, and a lowest bid price of the airspace C is 2, the lowest bid price of a flight plan using the airspaces A, B, and C is set to 3.

An example of update of the lowest bid price is provided below. For example, it is assumed that the auction mechanism is a method of provisionally assigning airspace in descending order of bid price. It is assumed that in a situation where the lowest bid price of the airspace A is 1, the lowest bid price of the airspace B is 3, and the lowest bid price of the airspace C is 2, a certain UAS operator bids the bid price 3 for a flight plan using the airspaces A, B, and C, and the airspaces are provisionally assigned to (the flight plan submitted by) the UAS operator. Since the provisional assignment is made preferentially to a higher bid price, a bid price higher than the bid price 3 for the combination of the airspaces A, B, and C has to be presented if a UAS operator wants to obtain the right of flight in one or more of the airspaces A, B, and C. Therefore, the flight plan approving system 10 may set the lowest bid price of each of the airspaces A, B, and C to 4, which is 1 unit higher than 3.

In step S14, the flight plan approving system 10 notifies relevant UAS operators of the result of the airspace provisional assignment and the updated lowest bid price. The notification may be a notification of only information indicating that provisional assignment or update of lowest bid price has been made. In that case, the provisional assignment or the lowest bid price may be managed in a database that can be referenced by UAS operators. In particular, the lowest bid price may be managed as airspace information in the available airspace database. In addition, the notification of the lowest bid price may also include information of the lowest bid price of the flight plan itself.

The UAS operator reviews the flight plan and the bid price upon reception of the airspace provisional assignment and the update of the lowest bid price (step S23). The review here does not necessarily mean a change, and for example, a UAS operator who has been provisionally assigned the airspace for which a bid has been made or a UAS operator who has submitted a flight plan having the lowest bid price having not been changed does not change the flight plan or the bid price, which may be a way of reviewing.

If the UAS operator changes the flight plan as a result of the review, he/she may make a flight plan again and bid for the new flight plan (return to step S21). The timing of bids for flight plans is determined according to the auction mechanism.

For example, in an auction in which bids are accepted for a certain period of time and provisional assignment is subsequently made, the UAS operator bids for a flight plan only during the bid acceptance period. In addition, there may be an auction in which bids are always accepted and the airspace provisional assignment is updated sequentially in response to a new bid. In the case of the latter auction method, the UAS operator can bid for a flight plan as soon as the UAS operator reviews the plan and makes a new flight plan.

If, as a result of the review, the UAS operator changes the bid price for the current flight plan, the operator may rebid for the current flight plan (return to step S22).

While UAS operators bid for the flight plans and update the bid prices as described above, the flight plan approving system 10 notifies the related UAS operators of closing of bidding when the close condition of the auction is satisfied (Yes in step S12). At this time, the flight plan approving system 10 may notify the UAS operators of closing of bidding only for a part of the airspaces for which each UAS operator has bid.

Next, the flight plan approving system 10 determines the assignment and the payment price of the airspace for which the auction has been closed (step S16). The payment price is determined, for example, according to the result of the assignment of the airspace, the bid price, and the auction mechanism. In many auctions, the bid price, which is the price specified at the time of bidding for the assigned airspace (combination of airspaces), is the payment price, but there may be an auction mechanism in which the bid price and the payment price are different.

In next step S17, the flight plan approving system 10 approves/disapproves the flight plan for the UAS operator, and notifies the UAS operator of the assignment and the payment price of the airspace. Approval/disapproval of the flight plan may be made, for example, in association with the result of the assignment of the airspaces. At this time, a flight plan, to which all required airspaces are assigned, is approved, and flight plans other than that are disapproved.

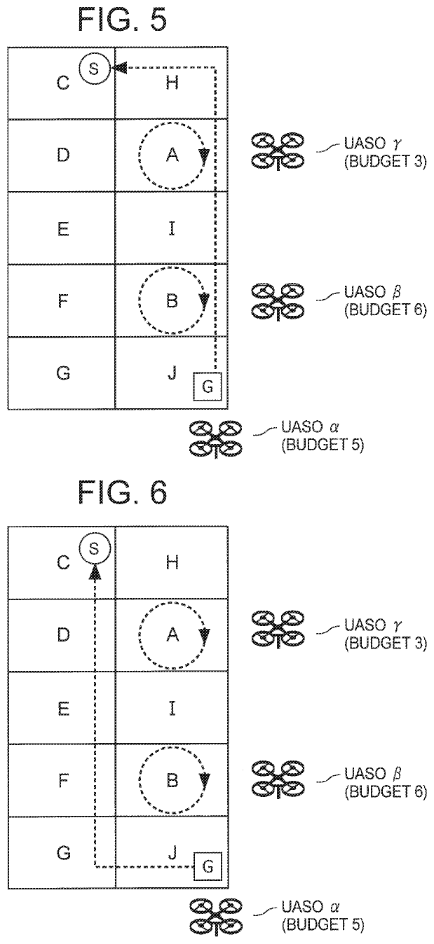

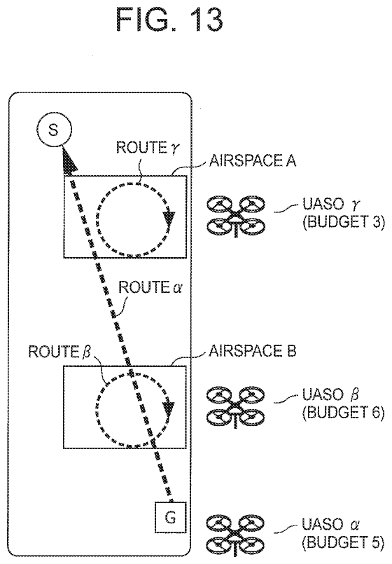

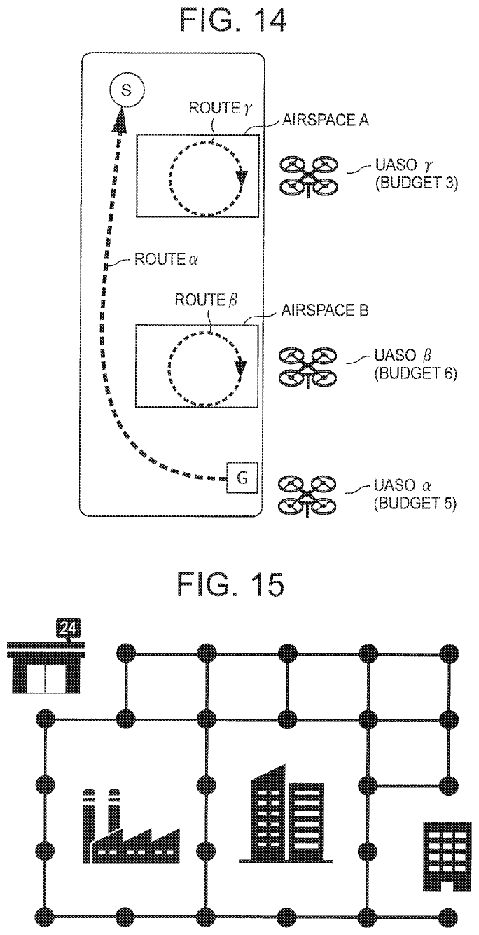

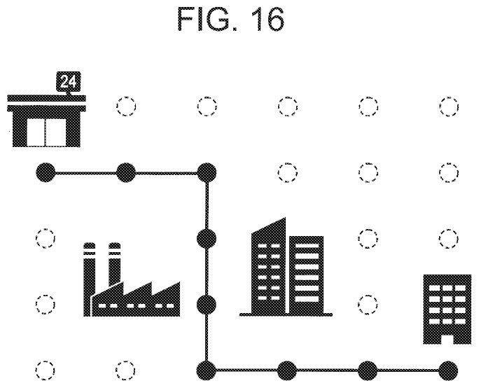

An example of a flow of the auction of the airspace license is described by using the situation shown in FIG. 13 as an example. FIG. 5 shows an example in which the situation shown in FIG. 13 is associated with the airspace information in the airspace license auction. It is assumed here that 10 airspaces (airspaces A to J) shown in FIG. 5 are auctioned.

The mechanism of this auction is assumed such that the bid price of a flight plan is associated with the bid price of a combination of airspaces used in the flight plan, and provisional assignment is made preferentially to a bid at higher bid price.

It is assumed here that a flight plan of a UAS operator α uses airspaces A, B, C, D, I, and J. It is also assumed that a flight plan of a UAS operator β uses only the airspace B. It is also assumed that a flight plan of a UAS operator γ uses only the airspace A.

In this example, it is assumed that the UAS operators α and γ bid for their own flight plans at prices that are the same as the respective budget prices. Specifically, the UAS operator α bids for the flight plan using the airspaces A, B, C, D, I, and J at the bid price 5, and the UAS operator γ bids for the flight plan using the airspace A at the bid price 3.

Here, the bid for the flight plan by the UAS operator α is associated with the bid for the combination of the airspaces A, B, C, D, I, and J at the bid price 5, and the bid for the flight plan by the UAS operator γ is associated with the bid for the airspace A at the bid price 3. Since bids at higher bid prices are prioritized, the flight plan approving system 10 provisionally assigns airspaces to the bid for the combination of the airspaces A, B, C, D, I, and J at the higher bid price. In other words, the flight plan of the UAS operator α is determined as the provisional assignment target of the airspaces A, B, C, D, I, and J.

After the provisional assignment is determined, the lowest bid price is updated. In this example, since the provisional assignment for the airspaces A, B, C, D, I, and J will not be changed unless there is a new bid for one or more of the airspaces A, B, C, D, I, and J at a bid price higher than the bid price 5, the flight plan approving system 10 updates the lowest bid price for these airspaces to 6.

The flight plan approving system 10 then transmits the provisional assignment and an update notification of the lowest bid price to UAS operators. Here, at least, the UAS operator α who is the provisional assignment target, and the UAS operator γ who made a bid for the airspace related to the updated lowest bid price but who did not become a provisional assignment target are notified.

The UAS operators who received the notification review their plans (flight plan and budget (bid price)). In this example, the UAS operator α does not change the flight plan or the bid price because the airspace is provisionally assigned to the flight plan of the UAS operator α. On the other hand, it is assumed that the UAS operator γ decides not to make a new bid for the flight plan because the lowest bid price of the flight plan exceeded the budget.

It is assumed that, in this state, the UAS operator β makes a bid for the airspace B at a bid price 6 equal to the budget price. The flight plan approving system 10 changes the provisional assignment of the airspace because a bid for the airspace B at a bid price higher than the current bid price 5 was made. In this example, the provisional assignment of the airspaces A, B, C, D, I, and J to the flight plan of the UAS operator α is cancelled, and the airspace B is provisionally assigned to the flight plan of the UAS operator β. At this time, the lowest bid price of the airspace B is set to 7. On the other hand, as for the airspaces A, C, D, I, and J, provisional assignment has not been made to any flight plan at that time. Thus, the lowest bid price will be updated to 0. In this manner, the flight plan approving system 10 makes a provisional assignment of airspaces for a flight plan as a unit.

The flight plan approving system 10 then transmits the provisional assignment and update notification of the lowest bid price to UAS operators. Here, at least, the UAS operator β who is the provisional assignment target, and the UAS operators α and γ who have bid for the airspace related to the updated lowest bid price in the past are notified.

In this example, it is assumed that the UAS operator α who has received the update notification decides not to make a new bid for the flight plan using the airspace B because the lowest bid price of the flight plan exceeded the budget. The UAS operator α then changes the flight plan to a flight plan using the airspaces C, D, E, F, G, and J without using the airspace B, and makes a new bid for the changed flight plan. On the other hand, the UAS operator γ, who has received the update notification, bids again for the flight plan using the airspace A since the lowest bid price of the airspace A becomes 0. It is assumed that, as a result, the airspaces C, D, E, F, G, and J are provisionally assigned to the new flight plan of the UAS operator α, and the airspace A is provisionally assigned to the flight plan of the UAS operator γ.

If no new bid is made thereafter and the close condition is satisfied, so that the airspace provisional assignments become the final assignments, the flight plans after efficient resolution of conflict as shown in FIG. 6 are approved. That is, as assignment of airspaces, a combination of the airspaces C, D, E, F, G, and J is assigned to the flight plan of the UAS operator α, the airspace B is assigned to the flight plan of the UAS operator β, and the airspace A is assigned to the flight plan of the UAS operator γ.

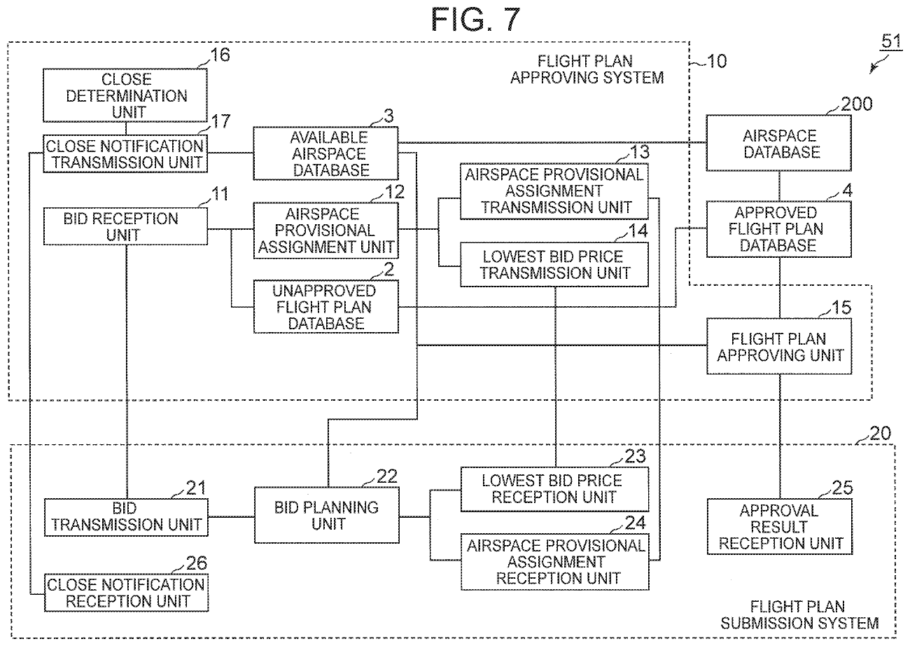

FIG. 7 is a block diagram showing a more detailed configuration example of the flight plan management system 51 of the present exemplary embodiment. FIG. 7 shows a configuration example of the flight plan approving system 10 and a flight plan submission system 20 on the UAS operator side that operates in cooperation with the flight plan approving system 10.

As shown in FIG. 7, the flight plan approving system 10 includes, in addition to the unapproved flight plan database 2 and the available airspace database 3, a bid reception unit 11, an airspace provisional assignment unit 12, an airspace provisional assignment transmission unit 13, a lowest bid price transmission unit 14, a flight plan approving unit 15, a close determination unit 16, and a close notification transmission unit 17.

The flight plan submission system 20 includes a bid transmission unit 21, a bid planning unit 22, a lowest bid price reception unit 23, an airspace provisional assignment reception unit 24, an approval result reception unit 25, and a close notification reception unit 26.

The function of each processing unit will be described with reference to the flowchart shown in FIG. 4.

In step S21, the bid planning unit 22 of the flight plan submission system 20 of a UAS operator makes a flight plan and determines a bid price of the made flight plan. In step S22, the bid transmission unit 21 bids for the flight plan according to the determination. In the flight plan approving system 10, the bid reception unit 11 receives the flight plan and the bid information for the flight plan. The bid information includes at least the bid price of the flight plan.

The received flight plan is stored in the unapproved flight plan database 2 and is transmitted to the airspace provisional assignment unit 12 together with the bid information. The airspace provisional assignment unit 12 computes the airspace provisional assignment and a lowest bid price of the related airspace on the basis of the bid information (step S11). The information of the airspace provisional assignment and the lowest bid price computed by the airspace provisional assignment unit 12 are transmitted to and managed by the available airspace database 3.

In the configuration shown in FIG. 7, the information of the airspace provisional assignment includes the information of the bid price. Separate databases may be provided for the airspace provisional assignment and the lowest bid price information as another method for managing the airspace provisional assignment and the lowest bid price. The update of the lowest bid price on the database corresponds to step S13.

In step S14, the airspace provisional assignment transmission unit 13 and the lowest bid price transmission unit 14 respectively transmit information indicating the computed airspace provisional assignment and lowest bid price to the UAS operator. The information to be transmitted may be information of the airspace provisional assignment and the information of the lowest bid price themselves, or the information indicating whether the airspace has been assigned to the bid for the flight plan made by the UAS operator and the information indicating that the lowest bid price has been updated.

On the UAS operator side, the airspace provisional assignment reception unit 24 and the lowest bid price reception unit 23 receive the information indicating the airspace provisional assignment and the lowest bid price, respectively. In step S23, the bid planning unit 22 then reviews the plan on the basis of the received information of the airspace provisional assignment and the lowest bid price. As a result, if it is necessary to make a change, the bid planning unit 22 makes a flight plan again in step S21. If the flight plan is changed or the bid price is updated, the bid transmission unit 21 again bids for the flight plan in step S22.

The close determination unit 16 determines the close condition in step S12. As a result, if there is an auction satisfying the close condition, a bid close notification is issued in step S15. The bid close notification is transmitted to the UAS operator by the close notification transmission unit 17 having received the information from the close determination unit 16. At this time, the close notification transmission unit 17 also transmits the information of the airspace for which bidding is closed to the available airspace database 3 to update the information of the airspace in the available airspace database 3, and also updates the information of the airspace in the airspace database 200 through the available airspace database 3.

For example, if the number of aircrafts allowed to fly in the available airspace finally assigned to a flight plan is 1, that airspace cannot be used by another flight plan. Thus, that airspace is deleted from the available airspace database 3. In addition, for example, if the number of aircrafts allowed to fly in the available airspace finally assigned to a certain flight plan is 2 or more, the number of aircrafts allowed to fly in the available airspace in the available airspace database 3 is decremented by 1. Further, for example, on the airspace database 200, the airspace provisional assignment information is changed to final assignment.

In addition, in response to the update of the available airspace database 3 and the like, the flight plan approving unit 15 computes the payment price of the airspace on the basis of the bid price of the flight plan including the airspace for which the provisional assignment was changed to the final assignment. This final assignment and determination of the payment price correspond to step S16.

If the flight plan approving unit 15 finds a flight plan for which all the airspace licenses required for the flight are granted from the auction result, the airspace assignment information on the airspace database 200, and the flight plan information on the unapproved flight plan database 2, the flight plan approving unit 15 registers the flight plan in the approved flight plan database 4.

The flight plan approving unit 15 transmits the result of approval/disapproval of the flight plan to the UAS operator on the basis of the auction result and the result of comparing the information in the unapproved flight plan database 2 and the information in the approved flight plan database 4. At the same time, the flight plan approving unit 15 also transmits information of the airspace assignment and information of the payment price to the UAS operator. However, if the UAS operator can refer to the airspace database 200, only update notification may be issued instead of transmitting the information of the airspace assignment.

Next, the correspondence between the configuration example shown in FIG. 7 and the schematic diagram of the flight plan management system 51 shown in FIG. 2 will be described.

To the airspace auction system 1 shown in FIG. 2, for example, the bid reception unit 11, the airspace provisional assignment unit 12, the airspace provisional assignment transmission unit 13, the lowest bid price transmission unit 14, the close determination unit 16, and the close notification transmission unit 17 correspond.

To the plan final approving system 5, a part of the flight plan approving unit 15 corresponds. More specifically, the plan final approving system 5 updates the approved flight plan database 4, coordinates pieces of information in the unapproved flight plan database 2 and the approved flight plan database 4, and determines the content of notification when the flight plan is approved/disapproved.

To the airspace assignment system 6, a part of the flight plan approving unit 15 corresponds. More specifically, the airspace assignment system 6 updates the airspace database 200. The update operation includes deletion of a part of airspaces from the available airspace database 3.

Although FIG. 1 shows an example including the flight monitoring system 61, the flight instruction system 62, and the flight status database 600 as the actual flight management system 52, the actual flight management system 52 does not have to have a special function as a process during flight, and a description thereof is not provided in the present exemplary embodiment.

For example, the flight monitoring system 61 monitors the UAS in flight and determines whether the flight is performed according to the flight plan. In addition, for example, when there is a UAS in flight that is not in accordance with the flight plan, the flight instruction system 62 instructs the related UAS operator to perform the flight in accordance with the flight plan, and transmits a notice information to other UAS operators that there is such UAS.

As described above, according to the above configuration, it is possible to contribute to the realization of efficient use of the sky in the flight of UASs in the sky.

For example, according to the present exemplary embodiment, the integrated flight management system 500 performs the setting of airspaces. Thus, by associating a flight plan with a combination of airspaces, conflict or interference of UASs between flight plans can be easily checked. In addition, since on the basis of the lowest bid prices of airspaces, the lowest bid price of a corresponding flight plan can be computed, the flight plan itself can be auctioned. Thus, an efficient use of the airspace by UASs can be realized.

This is because a method based on economic principle is introduced to determine which company (or flight plan) is granted the right to use an airspace, which is a natural resource. As a method of determining a company to be granted the right, there may be alternatives such as granting a company that firstly hopes for the right, and assigning any of company hoping for the right randomly. However, it is considered that the method based on economic principles is superior in the following respects.

First, it prevents occupation of unnecessary airspaces. If occupation of an airspace were allowed at no economic expense, a company would occupy an unnecessarily large airspace, either as a precaution or for the purpose of obstructing other companies. Second, capital investment can be recovered. A huge capital investment is required for sensors from the ground and the like for safe flight management, and it is natural that the burden of this infrastructure should be borne by the beneficiary. Third, the method acts as a lubricant for coordination among flight companies. This is because in considering the priority of flight operation from the viewpoint of business of the flight business and the priority from the viewpoint of public purpose, it is natural to make such priorities convertible with economic value, and it is considered that the convertibility may promote coordination among flight companies. Random assignment or assignment to a predecessor cannot appropriately reflect priority.

In a case where the introduction of economic principles is likely to impede the development of the industry due to increase of price, it is possible to adjust the frequency of airspace assignment in order to provide appropriate feedback on investment value. Frequent airspace assignment can modify prices that diverge from reality and prevent increase of price.

In addition, in a case where there is a concern about occupation by a specific enterprise, it is possible to coordinate assignment by, for example, granting a certain reservation right in advance to small enterprises, public entities, or the like.

The introduction of economic principles can be broadly divided into two phases. That is, a phase in which parties who hopes for a right of possession of each airspace are invited and a party who possesses the airspace is determined by a market mechanism (first phase), and a phase in which a company who hopes the right of possession to be transferred for a business purpose negotiates with the company between themselves after the party who possesses the airspace is determined (second phase).

For example, it is assumed that an airspace is divided in advance by latitude, light, altitude, and time according to its geographical characteristics and requirements, and each airspace is classified into one of no-fly airspace, shared airspace, and exclusive airspace. Such classification is performed by the control side (for example, the actual flight management system 52 described above) that primarily manages the airspace, and may be changed on a case-by-case basis depending on usage conditions, weather, or the like. Exclusive airspaces are further classified into airspaces occupied by a specific company and unoccupied airspaces. The airspaces occupied by a specific company are further classified into airspaces for which negotiation is possible and airspaces for which negotiation is not possible. In order to achieve a business mission using an airspace for which negotiation with another flight company is possible in addition to the already reserved airspace, unoccupied airspace, and shared airspace, a flight company may newly obtain a right of possession of an unoccupied airspace or start negotiation with another flight company.

Note that the present exemplary embodiment is for determination of assignment of airspaces in the first phase, but the present exemplary embodiment leaves room for negotiation in the later stage. Thus, further efficient utilization of the sky is expected.

It should be noted that the efficient use of the sky is also possible only by the first phase. That is, in the present exemplary embodiment, in order to achieve both safety and flexible flight service business, an airspace that can be exclusively used by a specific company can be set for each time, and this exclusive right is determined by an economic principle such as an auction. By setting such an exclusive airspace, flight plan adjustment in advance for collision avoidance becomes clear, and autonomous collision avoidance during flight can be possible by simpler technique. In the event of a collision, the responsibility for the collision will be clarified on the basis of the association of flight plans and airspaces. In addition, since a method based on economic principle is introduced as a method of assignment, occupation of unnecessary airspace can be prevented, and necessary capital investment can be easily recovered. In addition, the exchange of economic price is expected to facilitate the adjustment taking into account the priority of the flight company.

Further, according to the present exemplary embodiment, by determining airspaces corresponding to a flight plan, when monitoring a UAS in actual flight, it is possible to determine that the flight plan is deviated when the aircraft is in flight outside the corresponding airspace. Further, for example, by adjusting the size of the airspace and the time period, the safety margin such as a distance between UAS flight plans can be set on the integrated flight management system side, so that more efficient use of the sky can be realized.

Moreover, since the UAS operator can bid for the flight plan itself, it is not necessary to submit the flight plan and bid for airspaces separately, and the time and effort required until the approval of the flight plan can be reduced.

In the above exemplary embodiment, the integrated flight management system 500 has an airspace database that stores airspace information that is information about airspaces represented by three-dimensional spatial regions and temporal intervals, and may manage a flight plan specified as a series of waypoints represented by longitude, latitude, altitude and time submitted by a UAS operator that operates a UAS in association with a combination of airspaces through which a route indicated in the flight plan passes. On the basis of the airspace information, the integrated flight management system 500 may detect conflict or interference between a plurality of flight plans, and approve/disapprove a flight plan submitted by a UAS operator in response to the detected conflict or interference. At this time, the integrated flight management system 500 may include not only airspaces through which the route indicated in the flight plan passes but also adjacent airspaces in associating flight plans and airspaces. Furthermore, the integrated flight management system 500 may detect conflict or interference between flight plans on the basis of information about whether UASs equal to or more than those allowed to fly in the same airspace flies, which is indicated in the airspace information.

The integrated flight management system 500 may prompt a UAS operator to set a bid price for the flight plan submitted by the UAS operator at the time of acceptance of the flight plan. The integrated flight management system 500 may then associate the bid price set for the flight plan with the bid price of airspaces. The integrated flight management system 500 may approve a flight plan when all airspaces through which a UAS passes in the flight plan could be obtained ultimately. At this time, the integrated flight management system 500 may approve/disapprove the submitted flight plan depending on the set bid price, and request the UAS operator to make payment for the approved flight plan.

The integrated flight management system 500 may also accept a bid (submission of a flight plan and setting of bid price) for a plurality of times from a UAS operator before approval/disapproval of the flight plan. Whenever a bid is made for the flight plan, the integrated flight management system 500 may update the lowest bid price, which is the lowest possible bid price of each airspace according to the conflict between flight plans and the bid prices, and disclose the lowest bid price of each airspace to the UAS operators. As a result, it is possible to prompt the UAS operators to submit flight plans without conflict.

The integrated flight management system 500 may have a UASSP that intermediates with the UAS operator, and the UASSP may make a proxy bidding for or request modification of a flight plan submitted by a UAS operator contracted with the UASSP itself.

The integrated flight management system 500 may set in advance the airspace information including the number of UASs allowed to fly in the airspace.

The integrated flight management system 500 holds restrictions related to airspaces, and UAS operators may be allowed to freely set airspaces under the restrictions.

During actual flight of a UAS, the integrated flight management system 500 may determine that the UAS is deviating from the flight plan when the UAS is in flight in an airspace for which the UAS does not have a right of use, change the flight status of the UAS, which has deviated from the flight plan, make flight instruction to the UAS, and provide warning advise to UASs in flight in the vicinity of the UAS, for example.

When a collision occurs between UASs operated by a plurality of UAS operators, the integrated flight management system 500 may determine whether to determine which UAS is at fault, determine an airspace including a point in time and space from the information on the time and the 3D location of occurrence of the collision, and determine that if there is a UAS having a flight plan for which a flight permission in the airspace is not obtained among the UASs that collided, the UAS operator who submitted the flight plan is at fault.

In a case where danger is predicted in flight of a UAS due to sudden change of weather, the integrated flight management system 500 may refer to users from the airspace information of the airspace in which the danger is predicted and notify the UAS operators of the danger prediction information.

The integrated flight management system 500 may also provide UAS operators with an interface for displaying an available airspace according to the conditions, and enabling a UAS operator to generate a provisional flight plan by selecting airspaces that the UAS operator wants to use, to set lowest bid price of a flight plan, and to check a list of information about the lowest bid prices of airspaces to be used.

The integrated flight management system 500 may also include a system for submitting a flight plan, which facilitates bidding by a UAS operator and makes a flight plan on the basis of information other than a route submitted by the UAS operator, for example, departure point, departure time, arrival time, transit point, destination place, aircraft information, etc. For example, the system may compute a route plan and a safety margin on the basis of the information submitted by the UAS operator and the airspace information, and may make a flight plan that can be associated with the airspace.

In addition, the integrated flight management system 500 may include, in the airspace information, the information of the UAS operator who has the right of flight in the airspace, and in response to a request from a UAS operator, the integrated flight management system 500 may intermediate between the UAS operator who does not have a right of flight in the airspace and the UAS operator who has the right of flight in the airspace.

Further, when the right of flight in an airspace is transferred or exchanged as a result of negotiation between the UAS operators or between the UASSPs, the integrated flight management system 500 may change the flight plan or intermediate the payment according to the result.

The integrated flight management system 500 may enable setting, with respect to an airspace, of a price for use of a land corresponding to the airspace for a certain period of time defined by a landowner of the land, and may have a function of payment from the UAS operator having the right of flight in the airspace to the landowner of the land according to the bid price for the airspace.

The integrated flight management system 500 may set the lowest bid price, which is the lowest bid price required to bid for an airspace, for each airspace on the basis of data related to the correspondence between the airspace and a bidding price in the past, weather, and flight volume.

### Second Exemplary Embodiment

Next, a second exemplary embodiment of the present invention will be described. In the present exemplary embodiment, a UAS service provider (UASSP) and a point bidding system are further added to the configuration of the first exemplary embodiment. The point bidding system distributes points for bidding from an integrated flight management system 500 to UASSPs for each of certain periods according to the past flight records and the congestion status of UASs. The UASSPs use the points to bid for a flight plan as a proxy for a UAS operator.

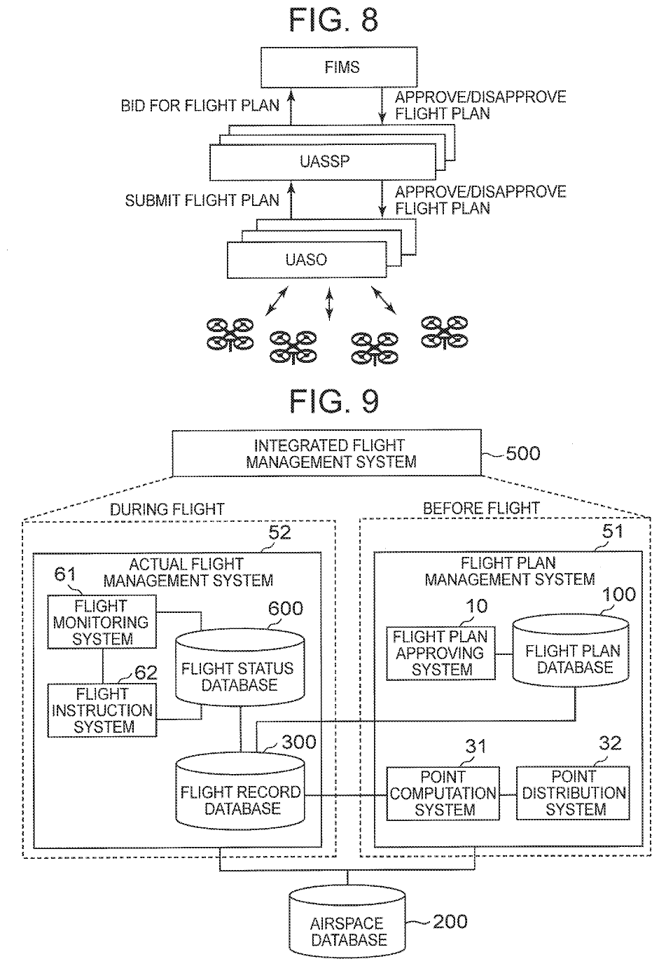

FIG. 8 is a schematic diagram of the integrated flight management system 500 of the present exemplary embodiment. In the present exemplary embodiment, UASSPs are provided between the FIMS (integrated flight management system 500) and UAS operators. In the present exemplary embodiment, a UAS operator submits a flight plan to the FIMS via a UASSP. The UASSP that received the flight plan also bids for the flight plan as a proxy for the UAS operator. As described above, the connection between the integrated flight management system 500 and a UAS operator can be performed via a UASSP. The UASSP is connected to a plurality of UAS operators, for example, and provides services for the UAS operators, such as connection to the integrated flight management system 500 and proxy bidding for a flight plan.

There may be a case, in which in the proxy bidding, the UAS operator transmits information such as a departure place, a destination place, an arrival time, and the like to the UASSP, and the UASSP side makes a specific flight plan and makes a bid. It is also possible that the bid price is not determined specifically by the UAS operator, but is determined on the UASSP side according to several types, such as a case where early successful bid is demanded or a case where successful bid is not demanded to be early. There may be a mechanism, in which the UAS operator pays a fee to the UASSP according to such type, and the UASSP sets a bid price according to the type and makes a bid.

In the present exemplary embodiment, points distributed from the integrated flight management system 500 side to the UASSP for each of certain periods are required when a bid is made. For example, 100 points are distributed from the integrated flight management system 500 side to a UASSP every month, and the UASSP uses the 100 points to make proxy bidding for a flight plan. A mechanism, in which a predetermined number of points are consumed each time a proxy bidding is made, is prepared.

The number of points to be distributed is determined by the integrated flight management system 500 on the basis of the number of UAS operators contracted with the UASSP and past flight records.

FIG. 9 is a block diagram showing a configuration example of the integrated flight management system 500 of the present exemplary embodiment. The integrated flight management system 500 shown in FIG. 9, compared with the configuration of the integrated flight management system 500 of the first exemplary embodiment shown in FIG. 1, further includes a flight record database 300, a point computation system 31, and a point distribution system 32.

The flight record database 300 stores flight record information. The flight record information includes at least route information of a route actually taken in flight by UASs. The flight record information may also include information regarding whether flight was performed as planned in comparison with the flight plan, the degree of congestion in an airspace as a result of flight of a plurality of UASs, and the like. Registration of flight record information in the flight record database 300 is performed by, for example, a flight monitoring system 61. The flight monitoring system 61 derives flight record information on the basis of the flight plan database 100 and a flight status database 600 for managing information about an actual flight status, and stores the flight record information in the flight record database 300.

The point computation system 31 determines the number of points to be distributed for each UASSP on the basis of the flight record information. The information referred to for the determination may include, in addition to the flight record information, UASSP information that is not related to flight such as the number of contracts of the UASSP with UAS operators. Points for bidding of the number determined by the point computation system 31 are distributed to each UASSP through the point distribution system 32.

In the present exemplary embodiment, the integrated flight management system 500 can control the number of UASs in flight and congestion of UASs by adjusting the number of points for bidding to be distributed to the UASSP. For example, in a case where flight of a UAS intermediated by a UASSP is causing congestion, the integrated flight management system 500 reduces the points to be distributed to the UASSP. This makes it difficult for the UASSP, for which the points are reduced, to bid for a flight plan using a congested airspace where conflict tends to increase the lowest bid price, and the UASSP avoids bidding. Thus, congestion is eased.

In addition, the integrated flight management system 500 can change the number of points for bidding to be distributed to a UASSP on the basis of the stored flight record that may indicate that flight was not performed even though an airspace was assigned to a flight plan, for example. For example, by reducing the number of points for bidding distributed to a UASSP that has bid for equal to or more than a given number of non-implemented flight plans, the integrated flight management system 500 can provide incentive for UAS operators who do not implement plans to make improvement. This facilitates implementation of flight according to flight plans, and reduces waste, for example, in a case where an airspace assigned to a flight plan is not used.

In addition, since the UASSP provides services such as proxy bidding to UAS operators, the UAS operators can easily participate in an auction, and the UAS operators can obtain approval of a UAS flight plan with less time and effort.

### Third Exemplary Embodiment

Next, a third exemplary embodiment of the present invention will be described. In the present exemplary embodiment, after the approval of a flight plan, airspace information is used in actual flight.

The system using the airspace information is roughly divided into two, that is, an integrated flight management system 500 side and the UAS operator side.

For example, a flight monitoring system 61 of an actual flight management system 52 may use the airspace information (in particular, information about the assignment target of each airspace) in monitoring a UAS. The flight monitoring system 61 monitors, for example, the position information of a UAS, obtains information about a user of an airspace including the position and time, and determines whether the UAS in flight has the right to use the airspace.

As a result of the determination, if a UAS is in flight in a non-licensed airspace, the flight monitoring system 61 may transmit information indicating that the UAS deviated from the approved flight plan to a flight instruction system 62. The flight instruction system 62 may perform processes including issuing a route modification instruction to a UAS operator who operates the UAS, notifying UAS operators of UASs in flight in nearby airspaces of information indicating that there is a UAS that deviates from the flight plan, and further issuing a caution.

When such a state occurs in which a UAS operates in a non-licensed airspace, the state may be reflected in the flight status stored in the flight status database 600. The flight status is provided to each UAS and generally has information indicating either before flight, during flight, or after flight. In this example, in addition to those statuses, a status of deviation from flight plan may be set, and this status may be given to a UAS in flight in a non-licensed airspace.

In addition, for example, the actual flight management system 52 may determine a UAS operator at fault using the airspace information when an accident occurs between UASs in flight. For example, when a plurality of UASs collides with each other, the actual flight management system 52 may divide the UASs into UASs having a right of flight in the airspace where the collision occurred and UASs having no right of flight in the airspace, and determine that the UAS operator side having no right is at fault.

For example, the actual flight management system 52 can use the airspace information when notifying UAS operators of information. The actual flight management system 52 can appropriately select a UAS operator that is notified of information using the airspace information by, for example, referring to the information of users of an airspace affected by sudden weather change or the like and notifying the UAS operator of the information of the sudden weather change or the like.

For example, the actual flight management system 52 can use the airspace information to match UASs to conditions such as the purpose of use. Although each exemplary embodiment has been described above on the premise that the right to use airspaces is left to the integrated flight management system 500 only, there may be a mechanism in which the right to use airspaces is given to landowners who own lands under the sky. In this case, the integrated flight management system 500 purchases the right of the sky from the right holder and realizes the system as described above.

In this case, it is natural that the usage fee of an airspace is paid to the landowner of the land below the airspace. Some landowners have a demand that allows transport drones to fly over their land, but does not allow photographic drones to fly over their land.

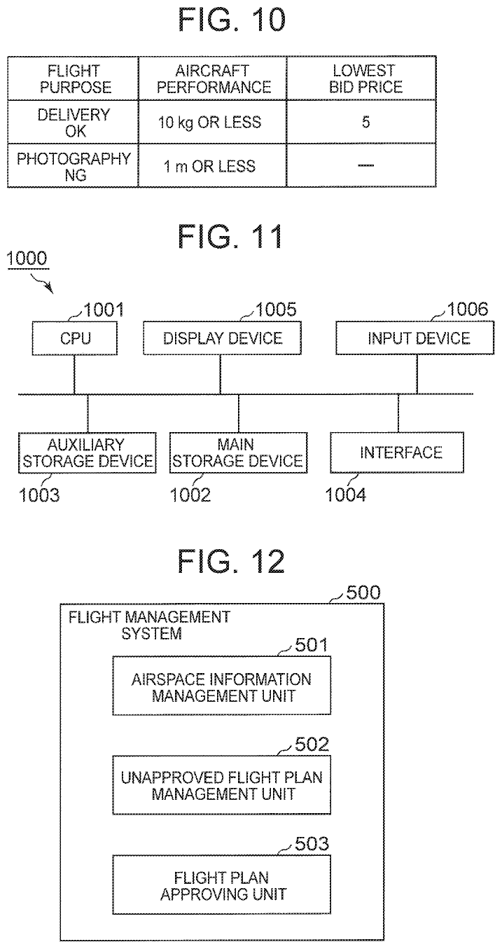

As a method for solving these problems, an item (limitation of purpose of use, etc.) which can be set by a landowner having the right may be added as a part of the airspace information. FIG. 10 is an explanatory diagram showing an example of information added to the airspace information. By adding the information shown in FIG. 10 to the airspace information, a UAS operator can, for example, determine whether the airspace is available by referring to the information. FIG. 10 shows an example of addition of the flight purpose, expected performance, and the lowest bid price for each airspace. According to the example shown in FIG. 10, it can be seen that an airspace is available for a transport UAS, but is not available for a photographic UAS, and is available for only a UAS having an aircraft weight of 10 kg or less and a size of 1 m or less, and the lowest bid price of the airspace is always 5 or more.

After an airspace is assigned, there may be a function of paying a price corresponding to the bid price for the airspace to the landowner who has the right of the airspace. In each of the above exemplary embodiments, bids for the approved flight plan are associated with airspaces, and a bid price for each airspace by the UAS operator is obtained. A flight plan management system 51 may associate the payment price to a payment price for each airspace used in the flight plan using such association and bid prices when determining the payment price for the flight plan form the UAS operator. A portion (or whole) of the price paid for the airspace may be provided to the landowners.

Further, examples of use on the UAS operator side include a system having an interface for displaying airspace information and the like in a format corresponding to a purpose. More specifically, an interface that displays available airspace after aircraft information and flight purpose are input, an interface for generating a provisional flight plan by specifying adjacent airspaces in time and space, and an interface that displays a lowest bid price for a flight plan and bid prices of airspaces to be used in a list from highest to lowest can be considered. These may be included, for example, in the flight plan submission system described above. For example, when the airspaces are displayed by the interface, blocks of the airspaces may be superimposed on the map. In this case, only available airspaces may be displayed, or airspaces to be used may be displayed in different display modes such as coloring. As another example of the display mode of airspaces, the display mode may be different depending on the lowest bid price. It is also possible to display airspaces according to altitude or time. For example, in making a flight plan, when a start point and a goal point are specified on a map showing airspaces, a route between them and the airspaces used by the route may be computed and highlighted. When the route is computed, the aircraft information may also be input. In this case, the route considering the moving speed, the safety margin, and the like can be computed on the basis of the aircraft information. In addition to automatically computing the route, it is also possible for an operator to specify an airspace adjacent to the start point, an airspace adjacent thereto, and so on in turns on the map showing the airspace to form the route accordingly.

In addition, when a UAS operator makes a flight plan and the right to use an airspace is already assigned to another UAS operator, the UAS operator may have a request for transfer of the right of use from the UAS operator having the right to use the airspace. In such a case, the integrated flight management system 500 may have a function of conducting a negotiation between UAS operators.

For example, a case where a request from a UAS operator to contact a UAS operator who has the right to use a certain airspace is considered. At this time, the integrated flight management system 500 can identify the UAS operator having the right of use from the airspace information, and contact the UAS operator by referring to the contact information of each UAS operator managed in the system. The integrated flight management system 500 may, for example, ask the UAS operator having the right of use whether communication with the UAS operator who has requested the communication may be accepted, and if so, communication between the UAS operators may be performed through the integrated flight management system 500.

Furthermore, the integrated flight management system 500 can change the flight plan and the airspace assignment on the basis of the negotiation result, and can transfer money (or points for bidding) associated with the change as a proxy. With this configuration, when an airspace is transferred as a result of the negotiation, the procedure in which the UAS operator having the right to use the airspace once returns the right to use the airspace, and then the other UAS operator obtains the right to use the airspace can be eliminated. For example, upon receiving the same information as the negotiation result information from UAS operators who participated in the negotiation as the negotiation result, the integrated flight management system 500 may consider that the negotiation is completed, and may change the airspace assignment (to users), withdraw or modify a flight plan, approve a new flight plan, or perform other processing according to the result.

As an example of transfer of money (or points for bidding) as a proxy, the integrated flight management system 500 may transfer money between UAS operators as a proxy using a system that is included in advance in the integrated flight management system 500 and that is for performing payment or refund for a flight plan with respect to each UAS operator. For example, a case where a negotiation from a UAS operator A to obtain a right to use a certain airspace by paying price 1 to a UAS operator B is settled is considered. In this case, the integrated flight management system 500 may change the user of the airspace from the UAS operator B to the UAS operator A, request the UAS operator A to pay price 1, and refund price 1 to the UAS operator B.

FIG. 11 is a schematic block diagram showing a configuration example of a computer according to each exemplary embodiment of the present invention. A computer 1000 includes a CPU 1001, a main storage device 1002, an auxiliary storage device 1003, an interface 1004, a display device 1005, and an input device 1006.

A server and other devices included in the integrated flight management system 500 of each of the above exemplary embodiments may be included in the computer 1000. In this case, the operation of each device may be stored in the form of a program in the auxiliary storage device 1003. The CPU 1001 loads a program from the auxiliary storage device 1003 onto the main storage device 1002, and performs predetermined processing in each exemplary embodiment according to the program. The CPU 1001 is an example of an information processing apparatus that operates according to a program, and may include a Micro Processing Unit (MPU), a Memory Control Unit (MCU), a Graphics Processing Unit (GPU), etc. other than the Central Processing Unit (CPU).

The auxiliary storage device 1003 is an example of a non-transitory tangible medium. Other examples of non-transient tangible medium include magnetic disks, magneto-optical disks, CD-ROMs, DVD-ROMs, semiconductor memories, and the like connected via the interface 1004. When the program is distributed to the computer 1000 through a communication line, the computer 1000 having received the distribution may load the program onto the main storage device 1002 and perform predetermined processing in each exemplary embodiment.

The program may be for realizing a part of the predetermined processing in each exemplary embodiment. Further, the program may be a difference program that realizes a predetermined processing in each exemplary embodiment in combination with other programs already stored in the auxiliary storage device 1003.

The interface 1004 transmits and receives information to and from other devices. The display device 1005 also presents information to a user. The input device 1006 accepts information input from a user.

Depending on the processing contents in an exemplary embodiment, some elements of the computer 1000 may be eliminated. For example, if the computer 1000 does not present information to a user, the display device 1005 may be eliminated. For example, if the computer 1000 does not accept information input from a user, the input device 1006 may be eliminated.

Further, some or all of the components of each of the above-described exemplary embodiments are implemented by a general-purpose circuitry or a dedicated circuitry, a processor, or the like, or a combination thereof. These may include a single chip or a plurality of chips connected via a bus. Further, some or all of the components of each of the above-described exemplary embodiments may be realized by a combination of a program and the circuitry or the like described above.

When some or all of the components of each of the above-described exemplary embodiments are realized by a plurality of information processing apparatuses, circuitries, and the like, the plurality of information processing apparatuses, the circuitries, and the like may be arranged in a centralized manner or in a distributed manner. For example, information processing apparatuses, circuitries, and the like may be implemented as a form in which they are connected to each other via a communication network, such as a client and server system, or a cloud computing system.

Next, an outline of the present invention will be described. FIG. 12 is a block diagram showing an outline of a flight management system of the present invention.

The flight management system 500 shown in FIG. 12 includes an airspace information management unit 501, an unapproved flight plan management unit 502, and a flight plan approving unit 503.

The airspace information management unit 501 (for example, the airspace database 200) manages airspace information, which is information related to an airspace represented by means of a three-dimensional spatial region and a temporal interval.

Upon reception of a flight plan for a moving body, the unapproved flight plan management unit 502 (for example, the airspace auction system 1 of the flight plan approving system 10) manages the flight plan in association with a combination of airspaces to be used in the flight plan, on the basis of the airspace information.

The flight plan approving unit 503 (for example, the plan final approving system 5 and the airspace assignment system 6 of the flight plan approving system 10), on the basis of the airspace information and the association described above made by the unapproved flight plan management unit 502, detects at least a conflict or an interference of airspaces between a plurality of flight plans, and approves or disapproves a flight plan on the basis of the result of detection.

With the above-described configuration, it is possible to safely and efficiently use the sky while reducing unnecessary payment from a company that operates a moving body.

The above-described exemplary embodiments can also be described as the following supplementary notes.

### (Supplementary Note 1)

A flight management system according to the present invention includes an airspace information management unit which manages airspace information, which is information related to an airspace represented by means of a three-dimensional spatial region and a temporal interval, an unapproved flight plan management unit which, upon reception of a flight plan for a moving body, manages the flight plan in association with a combination of airspaces to be used in the flight plan, on the basis of the airspace information, and a flight plan approving unit which, on the basis of the airspace information and the association described above, detects at least a conflict or an interference of airspaces between a plurality of flight plans, and approves or disapproves the flight plan on the basis of the result of detection.

### (Supplementary Note 2)

The flight management system according to supplementary note 1, wherein the unapproved flight plan management unit includes: a bid acceptance unit which accepts bidding for the flight plan with specification of a bid price along with the flight plan; and an airspace bid price determination unit which converts the bidding for the flight plan into bidding for the airspaces to be used in the flight plan, and determines a bid price for each of the airspaces to be used in the flight plan on the basis of the bidding price of the flight plan, and the flight plan approving unit determines, for a flight plan as a unit, an assignment target of the airspaces on the basis of whether there is bidding for each of the airspaces and the bid price of each of the airspaces, and approves a flight plan to which all airspaces used in the flight plan have been assigned as a result of the assignment target determination.

### (Supplementary Note 3)

The flight management system according to supplementary note 2, wherein the bid acceptance unit accepts biding for a flight plan using specified airspaces a plurality of times until a predetermined close condition is satisfied, and the airspace bid price determination unit updates a lowest bid price, which is a lowest price that can be bid, for each of the airspaces according to a state of conflict or interference between the accepted flight plans and bid prices.

### (Supplementary Note 4)

The flight management system according to supplementary note 2 or 3, wherein the airspace bid price determination unit sets a lowest bid price, which is a lowest price that can be bid, for an airspace on the basis of at least one of a past bid situation for the airspace, weather, and a past flight volume in the airspace.

### (Supplementary Note 5)

The flight management system according to any one of supplementary notes 1 to 4, wherein one or more service provider(s) who intermediates connection with a company conducting a flight operation of a moving body submits, as a proxy, a flight plan of the company on the basis of information provided from the company contracted with the provider itself.

### (Supplementary Note 6)

The flight management system according to supplementary note 5 further comprising a point distribution unit which distributes points required for submission of a flight plan to the service provider on the basis of a flight record of a flight plan having been submitted by the service provider.

### (Supplementary Note 7)

The flight management system according to any one of supplementary notes 1 to 6, wherein the airspace information includes information about the number of moving bodies allowed to fly in each airspace.

### (Supplementary Note 8)

The flight management system according to any one of supplementary notes 1 to 7, wherein an airspace may be defined freely by a company who submits a flight plan under a predetermined restriction related to an airspace.

### (Supplementary Note 9)

The flight management system according to any one of supplementary notes 1 to 8 further including: an approved flight plan management unit which manages an approved flight plan; a monitoring unit which monitors flight of a moving body; a flight instruction unit which, when a result of the monitoring indicates that the moving body is in flight in an airspace where the moving body does not have a right to fly, changes a flight status of the moving body, and issues a flight instruction to the moving body or provides warning advise to another moving body in flight in a vicinity of the moving body.

### (Supplementary Note 10)

The flight management system according to supplementary note 9, wherein when a collision occurs between moving bodies managed by different companies, the monitoring unit determines which company is at fault on the basis of flight plans of the moving bodies involved in the collision.

### (Supplementary Note 11)

The flight management system according to supplementary note 9 or 10, wherein when a danger is predicted in flight of a moving body, the monitoring unit notifies a moving body that may use an airspace where the danger is predicted or a company who operates the moving body of the danger on the basis of the airspace information of the airspace and the approved flight plan.

### (Supplementary Note 12)

The flight management system according to any one of supplementary notes 1 to 11 further comprising an interface unit configured to provide an interface for a company that operates a moving body, the interface being for at least one of displaying an available airspace, providing assistance in making a flight plan, setting of a lowest bid price for a flight plan, or displaying a lowest bid price for an airspace used in a flight plan having been submitted.

### (Supplementary Note 13)

The flight management system according to any one of supplementary notes 1 to 12 further comprising a bid planning unit which, upon receiving information including at least a departure point and a destination place, makes a route plan and make a flight plan on the basis of the received information.

### (Supplementary Note 14)

The flight management system according to any one of supplementary notes 1 to 13, wherein the airspace information includes information about a company who has a right to fly in each airspace, and the flight management system provides, at a request from a company, a way to communicate between a company that does not have a right to fly and a company that has a right to fly.

### (Supplementary Note 15)

The flight management system according to any one of supplementary notes 1 to 14, wherein the flight management system changes a flight plan and intermediates payment when a right to fly in an airspace is transferred or rights to fly in airspaces are exchanged between companies or between a company and a service provider who intermediates connection between the company and the flight management system.

### (Supplementary Note 16)

A flight management method performed by an information processing apparatus, including managing airspace information, which is information related to an airspace represented by means of a three-dimensional spatial region and a temporal interval, upon reception of a flight plan for a moving body, managing the flight plan in association with a combination of airspaces to be used in the flight plan, on the basis of the airspace information, and on the basis of the airspace information and the association described above, detecting at least a conflict or an interference of airspaces between a plurality of flight plans, and approving or disapproving the flight plan on the basis of the result of detection.

### (Supplementary Note 17)

A flight management program that causes a computer to store airspace information, which is information related to an airspace represented by means of a three-dimensional spatial region and a temporal interval in a predetermined storage device; upon reception of a flight plan for a moving body, store the flight plan in association with a combination of airspaces to be used in the flight plan, on the basis of the airspace information in a predetermined storage device; and on the basis of the airspace information and the association described above, detect at least a conflict or an interference of airspaces between a plurality of flight plans, and approve or disapprove the flight plan on the basis of the result of detection.

Although the present invention has been described above with reference to the exemplary embodiments and examples, the present invention is not limited to the exemplary embodiments and examples. Various changes can be made to the configuration and details of the present invention as will be understood by those skilled in the art within the scope of the present invention.

This application claims priority to U.S. Patent Application No. 62/532,547 filed on Jul. 14, 2017, the disclosure of which is hereby incorporated by reference in its entirety.

### INDUSTRIAL APPLICABILITY

The present invention is suitably applicable to any purposes of use, system, apparatus, method, and program in which efficient assignment of operation route resource of moving bodies is desired.

### REFERENCE SIGNS LIST

500 Integrated flight management system
200 Airspace database
51 Flight plan management System
100 Flight plan database
10 Flight plan approving system
1 Airspace auction system
2 Unapproved flight plan database
3 Available airspace database
4 Approved flight plan database
5 Plan final approving system
6 Airspace assignment system
11 Bid reception unit
12 Airspace provisional assignment unit
13 Airspace provisional assignment transmission unit
14 Lowest bid price transmission unit
15 Flight plan approving unit
16 Close determination unit
17 Close notification transmission unit
20 Flight plan submission system
21 Bid transmission unit
22 Bid planning unit
23 Lowest bid price reception unit
24 Airspace provisional assignment reception unit
25 Approval result reception unit
26 Close notification reception unit
52 Actual flight management system
600 Flight status database
61 Flight monitoring system
62 Flight instruction system
300 Flight record database
31 Point computation system
32 Point distribution system
1000 Computer
1001 CPU
1002 Main storage device
1003 Auxiliary storage device
1004 Interface
1005 Display device
1006 Input device

What is claimed is:

1. A flight management system comprising:
an airspace information management unit which manages airspace information, which is information related to an airspace represented by means of a three-dimensional spatial region and a temporal interval;
an unapproved flight plan management unit which, upon reception of a flight plan for a moving body, manages the flight plan in association with a combination of airspaces to be used in the flight plan, on the basis of the airspace information; and
a flight plan approving unit which, on the basis of the airspace information and the association described above, detects at least a conflict or an interference of airspaces between a plurality of flight plans, and approves or disapproves the flight plan on the basis of the result of detection.

2. The flight management system according to claim 1, wherein
the unapproved flight plan management unit includes:
a bid acceptance unit which accepts bidding for the flight plan with specification of a bid price along with the flight plan; and
an airspace bid price determination unit which converts the bidding for the flight plan into bidding for the airspaces to be used in the flight plan, and determines a bid price for each of the airspaces to be used in the flight plan on the basis of the bidding price of the flight plan, and
the flight plan approving unit determines, for a flight plan as a unit, an assignment target of the airspaces on the basis of whether there is bidding for each of the airspaces and the bid price of each of the airspaces, and approves a flight plan to which all airspaces used in the flight plan have been assigned as a result of the assignment target determination.

3. The flight management system according to claim 2, wherein
the bid acceptance unit accepts biding for a flight plan using specified airspaces a plurality of times until a predetermined close condition is satisfied, and
the airspace bid price determination unit updates a lowest bid price, which is a lowest price that can be bid, for each of the airspaces according to a state of conflict or interference between the accepted flight plans and bid prices.

4. The flight management system according to claim 2, wherein the airspace bid price determination unit sets a lowest bid price, which is a lowest price that can be bid, for an airspace on the basis of at least one of a past bid situation for the airspace, weather, and a past flight volume in the airspace.

5. The flight management system according to claim 1, wherein one or more service provider(s) who intermediates connection with a company conducting a flight operation of a moving body submits, as a proxy, a flight plan of the company on the basis of information provided from the company contracted with the provider itself.

6. The flight management system according to claim 5 further comprising a point distribution unit which distributes points required for submission of a flight plan to the service provider on the basis of a flight record of a flight plan having been submitted by the service provider.

7. The flight management system according to claim 1, wherein the airspace information includes information about the number of moving bodies allowed to fly in each airspace.

8. The flight management system according to claim 1, wherein an airspace may be defined freely by a company who submits a flight plan under a predetermined restriction related to an airspace.

9. The flight management system according to claim 1, further comprising:
an approved flight plan management unit which manages an approved flight plan;
a monitoring unit which monitors flight of a moving body;
a flight instruction unit which, when a result of the monitoring indicates that the moving body is in flight in an airspace where the moving body does not have a right to fly, changes a flight status of the moving body, and issues a flight instruction to the moving body or provides warning advise to another moving body in flight in a vicinity of the moving body.

10. The flight management system according to claim 9, wherein when a collision occurs between moving bodies managed by different companies, the monitoring unit determines which company is at fault on the basis of flight plans of the moving bodies involved in the collision.

11. The flight management system according to claim 9, wherein when a danger is predicted in flight of a moving body, the monitoring unit notifies a moving body that may use an airspace where the danger is predicted or a company who operates the moving body of the danger on the basis of the airspace information of the airspace and the approved flight plan.

12. The flight management system according to claim 1 further comprising an interface unit configured to provide an interface for a company that operates a moving body, the interface being for at least one of displaying an available airspace, providing assistance in making a flight plan, setting of a lowest bid price for a flight plan, or displaying a lowest bid price for an airspace used in a flight plan having been submitted.

13. The flight management system according to claim 1 further comprising a bid planning unit which, upon receiving information including at least a departure point and a destination place, makes a route plan and make a flight plan on the basis of the received information.

14. The flight management system according to claim 1, wherein
the airspace information includes information about a company who has a right to fly in each airspace, and
the flight management system provides, at a request from a company, a way to communicate between a company that does not have a right to fly and a company that has a right to fly.

15. The flight management system according to claim 1, wherein the flight management system changes a flight plan and intermediates payment when a right to fly in an airspace is transferred or rights to fly in airspaces are exchanged between companies or between a company and a service provider who intermediates connection between the company and the flight management system.

16. A flight management method performed by an information processing apparatus, comprising:
managing airspace information, which is information related to an airspace represented by means of a three-dimensional spatial region and a temporal interval;
upon reception of a flight plan for a moving body, managing the flight plan in association with a combination of airspaces to be used in the flight plan, on the basis of the airspace information; and
on the basis of the airspace information and the association described above, detecting at least a conflict or an interference of airspaces between a plurality of flight plans, and approving or disapproving the flight plan on the basis of the result of detection.

17. A non-transitory computer-readable capturing medium having captured therein a flight management program that causes a computer to:
store airspace information, which is information related to an airspace represented by means of a three-dimensional spatial region and a temporal interval in a predetermined storage device;
upon reception of a flight plan for a moving body, store the flight plan in association with a combination of airspaces to be used in the flight plan, on the basis of the airspace information in a predetermined storage device; and
on the basis of the airspace information and the association described above, detect at least a conflict or an interference of airspaces between a plurality of flight plans, and approve or disapprove the flight plan on the basis of the result of detection.

18. The flight management system according to claim 3, wherein the airspace bid price determination unit sets a lowest bid price, which is a lowest price that can be bid, for an airspace on the basis of at least one of a past bid situation for the airspace, weather, and a past flight volume in the airspace.

19. The flight management system according to claim 2, wherein one or more service provider(s) who intermediates connection with a company conducting a flight operation of a moving body submits, as a proxy, a flight plan of the company on the basis of information provided from the company contracted with the provider itself.

20. The flight management system according to claim 3, wherein one or more service provider(s) who intermediates connection with a company conducting a flight operation of a moving body submits, as a proxy, a flight plan of the company on the basis of information provided from the company contracted with the provider itself.
